(19) United States
(12) Patent Application Publication
(10) Pub. No.: US 2003/0187798 A1
(43) Pub. Date: Oct. 2, 2003

(54) Digital watermarking methods, programs and apparatus

(76) Inventors: Tyler J. McKinley, West Linn, OR (US); Brett T. Hannigan, Portland, OR (US); Phillip Andrew Seder, Portland, OR (US); J. Scott Carr, Tualatin, OR (US); Geoffrey B. Rhoads, West Linn, OR (US); Reed R. Stager, Portland, OR (US); William Y. Conwell, Portland, OR (US); Joel R. Meyer, Lake Oswego, OR (US); Matthew M. Weaver, Wilsonville, OR (US); Michelle Simone Christopher, Hillsboro, OR (US); Kenneth L. Levy, (US)

Correspondence Address: DIGIMARC CORPORATION, 19801 SW 72ND AVENUE, SUITE 100, TUALATIN, OR, 97062, US

(21) Appl. No.: 10/265,348

(22) Filed: Oct. 4, 2002

Related U.S. Application Data
(63) Continuation-in-part of application No. 10/122,141, filed on Apr. 12, 2002.
(63) Continuation-in-part of application No. 10/012,676, filed on Nov. 5, 2001.
(60) Provisional application No. 60/327,687, filed on Oct. 5, 2001.
(60) Provisional application No. 60/284,163, filed on Apr. 16, 2001.

(51) Int. Cl. H04K 1/00; H04L 9/00; G06F 17/60; G09C 3/00; G09C 5/00; H04N 7/167

(52) U.S. Cl. 705/50; 713/185; 380/205; 380/54

(57) ABSTRACT

The present invention provides various methods and apparatus used in connection with steganography and digital watermarking. In one implementation, a method of obtaining information from a network of computers based at least in part on the environment associated with a first computer is provided. An object is presented within the field of view of an optical sensor device. The optical device is in communication with a first computer. The object includes plural-bit data steganographically encoded in the object. The first computer communicates with at least a second computer in the network of computers. Optical data corresponding to the object is acquired, and the plural-bit digital data is decoded from the optical data. At least some of the decoded data and environmental data is submitted to the second computer, which determines which information to send to the first computer based on the environmental data. Many other embodiments are disclosed herein.

### RELATED APPLICATION DATA

The present application claims the benefit of U.S. Provisional Patent Application No. 60/327,687, filed Oct. 5, 2001. The present invention is also a continuation in part of U.S. patent application Ser. No. 10/122,141, filed Apr. 12, 2002, which claims priority to U.S. Provisional Application No. 60/284,163, filed Apr. 16, 2001. The present invention is also a continuation in part of U.S. Pat. Ser. No. 10/012,676, filed Nov. 5, 2001. The present application is also related to U.S. patent application Ser. Nos. 09/571,422, filed May 15, 2000 and 09/515,545, filed Feb. 29, 2000, and U.S. Pat. Nos. 6,324,573, 6,122,403 and 5,841,978. Each of these patent documents is herein incorporated by reference.

### BACKGROUND OF THE INVENTION

Digital watermarking technology, a form of steganography, encompasses a great variety of techniques by which plural bits of digital data are hidden in some other object, preferably without leaving human-apparent evidence of alteration.

Digital watermarking may be used to modify media content to embed a machine-readable code into the media content. The media may be modified such that the embedded code is imperceptible or nearly imperceptible to the user, yet may be detected through an automated detection process.

There are many processes by which media can be processed to encode a digital watermark. In physical objects, the data may be encoded in the form of surface texturing, or printing. Such marking can be detected from optical scan data, e.g., from a scanner or web cam. In electronic objects (e.g., digital audio or imagery—including video), the data may be encoded as slight variations in sample values. Or, if the object is represented in a so-called orthogonal domain (also termed “non-perceptual,” e.g., MPEG, DCT, wavelet, etc.), the data may be encoded as slight variations in quantization values or levels. The present Assignee's U.S. Pat. No. 6,122,403 and application Ser. No. 09/503,881 are illustrative of certain watermarking technologies.

Digital watermarking systems typically have two primary components: an embedding component that embeds a watermark in the media content, and a reading component that detects and reads the embedded watermark. The embedding component embeds a watermark pattern by altering data samples of the media content. The reading component analyzes content to detect whether a watermark pattern is present. In applications where the watermark encodes information, the reading component extracts this information from the detected watermark.

One problem that arises in many watermarking applications is that of object corruption. If the object is reproduced, or distorted, in some manner such that the content presented for watermark decoding is not identical to the object as originally watermarked, then the decoding process may be unable to recognize and decode the watermark. To deal with such problems, the watermark can convey a reference signal. The reference signal is of such a character as to permit its detection even in the presence of relatively severe distortion. Once found, the attributes of the distorted reference signal can be used to quantify the content's distortion. Watermark decoding can then proceed—informed by information about the particular distortion present.

The Assignee's U.S. patent application Ser. Nos. 09/503,881 and 09/452,023 detail certain reference signals, and processing methods, that permit such watermark decoding even in the presence of distortion. In some image watermarking embodiments, the reference signal comprises a constellation of quasi-impulse functions in the Fourier magnitude domain, each with pseudorandom phase. To detect and quantify the distortion, the watermark decoder converts the watermarked image to the Fourier magnitude domain and then performs a log polar resampling of the Fourier magnitude image. A generalized matched filter correlates the known orientation signal with the re-sampled watermarked signal to find the rotation and scale parameters providing the highest correlation. The watermark decoder performs additional correlation operations between the phase information of the known orientation signal and the watermarked signal to determine translation parameters, which identify the origin of the watermark message signal. Having determined the rotation, scale and translation of the watermark signal, the reader then adjusts the image data to compensate for this distortion, and extracts the watermark message signal as described above.

To provide a comprehensive disclosure without unduly lengthening this specification, each of the patents and patent applications cited in this specification are herein incorporated by reference.

With the foregoing by way of background, the specification next turns to various digital watermarking improvements. It will be recognized that these improvements can typically be employed in many applications, and in various combinations with the subject matter of the patent documents cited herein. These improvements will be more readily apparent from the following detailed description, which proceeds with reference to the accompanying drawings.

### BRIEF DESCRIPTION OF THE DRAWINGS

FIGS. 1a and 1b are diagrams for various spot color detection techniques.

FIG. 2 is a block diagram of a watermark reader.

FIGS. 3a and 3b are diagrams illustrating another watermark reader.

FIG. 4 is a diagram illustrating yet another watermark reader, in which a prism is used as a communications channel.

FIG. 5 is a screen shot of a graphical user interface (GUI) helpful to associate a computer command with a watermark identifier.

### DETAILED DESCRIPTION

Product Cards

Theft of audio and video products from retail stores is a continuing concern. Millions of dollars are annually lost as shoplifters and other thieves walk out the front door with CDs, DVDs, etc. Anti-theft devices have curtailed theft—but at a significant packaging price.

Our improvements provide a relatively inexpensive solution to even further curtail theft and reduce manufacturing costs. Physical media, e.g., CDs, DVDs (audio and video), SACDs, mini-CDs, etc. that is typically found on store shelves is replaced with digitally watermarked cards (or other physical objects).

In one embodiment, product packaging, e.g., album covers, brochure, CD jewel cases or video jackets, etc., remains on store shelves for consumer perusal. A customer presents a product selection to a store clerk (or automated checkout process). The customer purchases a digitally watermarked card that is associated with the product selection. The association may be achieved through a digital watermark. In some cases the product package includes a digital watermark. The digital watermark is decoded from the product package and is used to identify or create an appropriate card.

The watermark encoding of the card can encompass artwork or printing on the card, the card's background, a laminate layer applied to the card, surface texture, etc. If a photograph or design is present, it too can be encoded. A variety of watermark encoding techniques are detailed in the patents and applications cited in this document; artisans in the field know many more. The digital watermark preferably includes a code or identifier.

The card is presented to a digital camera, scanner, optical sensor, or web camera to capture an image of the card. The captured image is analyzed by watermark detection software (or a hardware/software combination). The identifier is extracted by the watermark detector and the user's computer is directed to a target website. (Of course, the user computer can be directed to the website via information provided by a centralized router based on the identifier.). Assignee's U.S. Pat. Ser. No. 09/571,422, filed May 15, 2000, further describes methods for linking an object to an internet website or other network resource. Such linking methods are suitably interchangeable with this aspect of the present invention.

The target website preferably includes a digital copy of the album, song or video. The user downloads the album or video to her computer. The target website is optionally a private site, which means that the target website is assessable to users only via the watermarked card. In this case, copying or book marking the target website URL (or link) preferably will not enable user access to the website since the link is enabled by a central routing system that receives the watermark ID from a user computer. IP address checking and time stamping are some of the ways to help secure a private website. Assignee's U.S. patent application Ser. Nos. 09/853,835, filed May 10, 2001, and 09/864,084, filed May 22, 2001, disclose still other techniques for securing a private website. Such website security techniques may be suitably interchanged with this aspect of the present invention.

The digital content can be further watermarked to help control unauthorized redistribution after downloading. The watermark may also include “self-destroy” instructions or a link to such instructions. For example, the watermark may include (or point to) an expiration date. The watermark will indicate, or help prohibit, rendering after expiration. Or the watermark may include an identifier that must correlate with the user's computer or rendering device. If the watermark does not match the device or computer, then play will be limited.

As an alternative security measure the number of permissible downloads is regulated. In this scenario, the watermarked card is preferable serialized, e.g., the watermark identifier uniquely identifies a particular card. The target website (or an associated database) records the number of downloads per identifier. When the limit is reached, the website prohibits access to the downloadable files.

In another implementation, a digitally watermarked card must be “activated” before linking is permitted. Theft of a digitally watermarked card is then useless, unless the card is first activated. A card can be activated in a number of ways. First, an authorized retailer (or distributor) is given a “master” card. This master card includes a digital watermark that is used to link the retailer to an activation website. (Alternatively, the retailer accesses the activation website in a conventional manner, e.g., via a URL and password login.). Once in communication with the activation website, the retailer presents the purchased watermarked card to an input device such as a digital camera, web camera, scanner, etc. An identifier is extracted via a watermark reader and the identifier is listed or otherwise flagged as an activated identifier. The user is then allowed to access the relevant content. The website can be unique to a particular artist (or label/manufacture). Or the content website (e.g., a target website) can be a centralized site representing many or all of the watermarked cards and content.

As a variation, the retailer associates content with a particular watermark identifier. In this case, watermarked cards are serialized (e.g., they include a unique identifier). However, the watermark identifiers are not assigned to specific content until the card is activated as discussed above. A retailer then selects an album, video, software or other content to be associated with the individual identifier.

As another variation, a purchaser activates a card, downloads the content, and/or selects content via a store kiosk. In this case the purchased content can be optionally downloaded directly from the kiosk to a rendering device (e.g., an MP3 player, CD-burner, or storage device).

Another benefit of a digitally watermarked card is ease of Internet navigation. After buying a card, a user can link directly to a site to download the album, song, video or software. This benefit disposes of the tedious task of typing in a long IP address or URL. To download a song by, e.g., Holly Tomas, one may have to navigate through a multiple web pages and ended up with address like:

http://play.mp3.com/play?redirect=play.mp3.com/cgi-bin/play/play.cgi/AAIBQiVaCABBAAAAAMAEbm9ybVAEAAAAUrSYAQBRAQAA AAgAQ.0nMTt..etk7c8eOxJ_hAa8_XU_/love_the_way.m3u&refer=http%3A%2F%2Fa rtists.mp3s.com%2Fartists%2F104%2Fholly_tomas.html

The inventive watermark card provides a direct link to the desired content for downloading.

Another benefit is a significant reduction in manufacturing costs. Instead of reproducing millions of albums, videos or software on physical media (e.g., CDs, SACDs and DVDs), millions of digitally watermarked cards can be produced, at a fraction of the cost.

Image Segmentation

In Assignee's U.S. patent application Ser. No. 09/706,505, filed Nov. 2, 2000, we disclosed that a batch registration system could supply embedder control files to a different, perhaps Internet server-based embedder computer. One advantage of this approach is to perform embedding of large batches on a more powerful computer or array of computers. In particular, a computer with multiple processors or an array of computers can embed watermark messages into corresponding media signal files in parallel processes. For large media signal files, or files that will be embedded with multiple, and potentially different watermark messages, parallel embedding processes can embed these watermark messages into different parts of a media signal from a single file in parallel. For example, a still image typically is divided into contiguous blocks of pixels, each carrying a watermark message. Similarly, temporal or spatial regions of a sequence of video frames can be subdivided and embedded with the same or different watermark messages. In video, for instance, one sequence of frames may be linked to a first web site relating to the content in that sequence, while another sequence may be linked to a second web site relating to the content in that sequence. A similar approach may be applied to segments of a music file, or different music tracks in a file having the songs of a particular CD.

An improvement involves optimizing the segmentation of an image for parallel processing (or the “prioritization” of image segments for parallel processing) to facilitate watermark embedding and/or decoding.

A first method prioritizes color planes (e.g., RGB, CMYK, L*a*b, etc.) according to their importance or watermark carrying significance. For example, a magenta (M) color plane may include a primary watermark component. Or there may be a strong likelihood that a watermark component is recoverable from a yellow (Y) color plane. Accordingly, these color planes are more highly prioritized over other image color planes. Within a highly prioritized plane, the plane itself can be further segmented, e.g., sequentially tiled or segmented according to further prioritization criteria. A related method prioritizes only those color planes that are likely to survive further system processing. To illustrate, a color plane that is going to be subsampled in video preferably receives a lower prioritization.

A second method prioritizes image regions according to workflow. In a first example, image segments are prioritized by location in a dot-gain compensation curve; or by the minimum/maximum dot held by a press.

A third method prioritizes an image according to spatially based algorithms. A first implementation prioritizes the image by arranging the image in blocks. The image can be blocked sequentially, starting left to right, top to bottom, etc. Or the image can be blocked according to image areas. Or the image can be segmented by other sequentially blocking methods. A second implementation prioritizes images area according to input “bands” for specific devices. For example, various printers process image information in data bands (or images strips or segments). (Or, thirdly, various bus structures communicate data in bands of data. The image can therefore be parallel processed for watermarking in accordance to these bands, or in accordance to the priority placed on these bans by a specific device.) A fourth implementation prioritizes image segments based on a statistical probability of important content being located in a particular image area. Those regions with a higher probability are processed prior to those with a lower probability. As a fifth implementation, an image is processed according to a function of outside variables. For instance, a stream of content includes an outside indicator evidencing available CPU bandwidth. The stream of content is processed according to the CPU bandwidth indicator. Or the indicator may serve as a traffic cop, directing a next image block or content stream to a particular processor or memory cache. A sixth implementation determines priority based on an image mask. In this implementation, the mask preferably highlights those image areas that should be given priority for embedding or decoding. Color components (CMYK) can be masked over a background spot color, or CMY planes can be masked over a black channel. Or image objects or high variance image areas are masked for watermarking. A seventh implementation uses cascaded low pass filters to reduce image resolution before decoding a watermark. A first stage filter preferably provides a power of 2 reduction, e.g., using a conventional filter (of typical speed and cutoff characteristics), followed by a conventional FIR filter on a smaller portion of the image. For example, a 300 lpi image is reduced to 150 lpi with a 2*2 average. A conventional FIR filter is then applied to the 150 lpi image (e.g., ¼ of the original data).

A fourth method for optimizing segmentation of an image for parallel processing prioritizes image areas based on parameters unique to the embedding hardware. For instance, watermark content (e.g., image data) that is already in a memory cache for another purpose is queued up for embedded prior to non-cached content. Or embedding occurs only on a “page” (or other measurable amount) of memory that is swapped into memory (e.g., for a virtual memory system). Still another implementation embeds a specific bit plane, e.g., by reducing the number of bits “tweaked” (or modified) in order to embed a watermark signal. Another implementation performs a sparse jump by only embedding content that is on memory alignment boundaries for a particular system. Or embedding only image content when there are idle cycles in a CPU(s) (e.g., instead of having the CPU(s) in a penalty state for a memory fetch).

In Assignee's U.S. patent application Ser. Nos. 09/302,663 and 09/945,244 we disclosed methods and apparatus to detect the presence of a digital watermark in an image by selecting regions within the image having a high probability of containing the watermark. An image is examined to determine which regions of the image have characteristics indicating that there is a high probability that a watermark signal can be detected in that region of the image. The regions that have a high probability that a watermark can be detected (in contrast to all regions of the image) are examined to find watermark data. The following prioritizing methods are preferably employed after such image or data stream preprocessing.

In a first method, only those image areas that will have minimal visual impact, as defined by variables passed to a human visual system (HVS) model (e.g., lighting, distance, skin-tones, edginess, etc.) are prioritized for watermark decoding. Or the parallel-processing prioritization takes into account other variables in a workflow (e.g., line screen, etc.) to determine what areas of an image to watermark or decode.

A second method proceeds according to a “threat analysis.” A “threat” is defined broadly herein and may include a threat of a watermark attack (e.g., a robustness issue), a threat of visual impairment, a threat of image corruption, etc. A first implementation analyzes the most common threats to a specific image and then divides (e.g., segments) the image according to the threat. For each segment, or for a set of segments, a different watermark technique can be applied. A second implementation analyzes what threats are the most effective for different areas of the image and then divides the image accordingly, e.g., divides the image so as to thwart the attacks.

A third method prioritizes images for watermark embedding or decoding based on an image metric. In a first case, the prioritization (or segmentation) is based on a standard image metric such as STDEV, etc. In a second case, the prioritization is based on a probability of a false positive (e.g., detecting a watermark signal when no such signal exists) in an unwatermarked region of an image. In a third case, the prioritization is based on the information carrying capacity of different image regions. Those regions with a higher capacity are prioritized above those with lower capacities.

A fourth method relies on contextual data to assist in the prioritization of processing an image. In a first case, an image is segmented based on it's content. In this case, content can be inferred by surrounding content (e.g., spatially and temporally in a image or video stream). In another case, an image is segmented (or otherwise prioritized) as a function of how the image is being used. For example, in a DVD playback, the image is segmented according to which portions of a video frame are zoomed or highlighted.

Of course, the above methods apply equally as well to video frames, images, and in some cases, to audio.

Spot Color Detection

Assignee has previously disclosed various “spot color” watermark-embedding techniques. See Assignee's U.S. patent application Ser. No. ______ ,filed Sept. 25, 2001, titled “EMBEDDING DIGITAL WATERMARKS IN SPOT COLORS” (Attorney Docket No. P0351). Some of these techniques embed a watermark signal by modulating CMY or CMYK process inks to approximate or fill-in a spot color. Other techniques embedded a signal by changing the luminance or intensity of the spot color at various spot color locations.

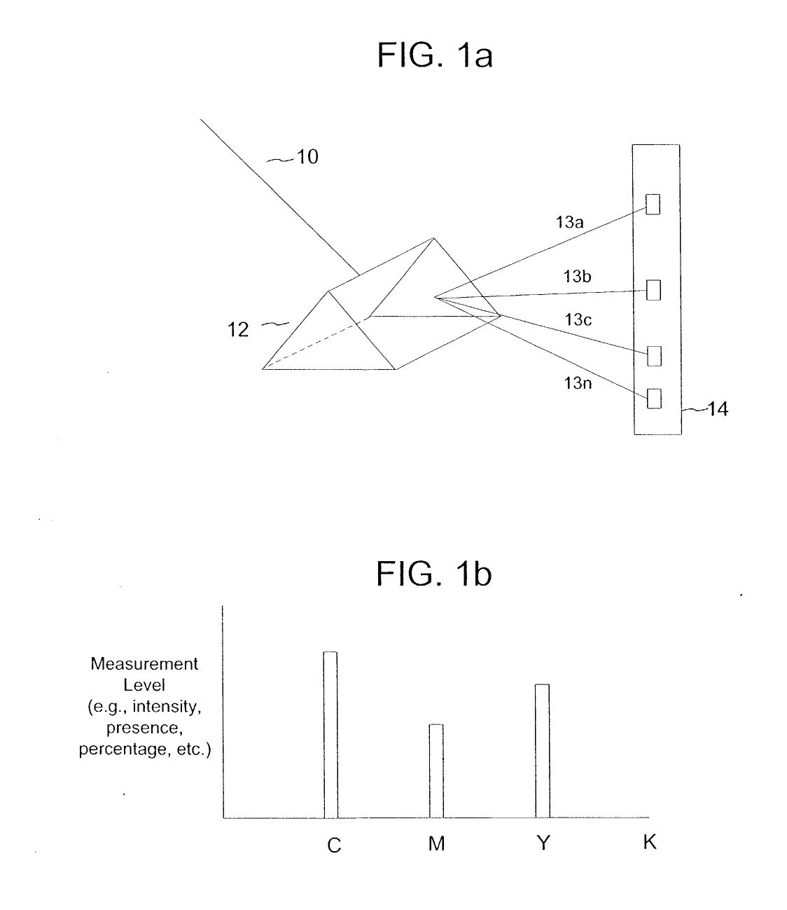

Our spot color detection improvement verifies authenticity of a spot color by analyzing component colors of the spot color. With reference to FIGS. 1a and 1b, a spot color emission (e.g., light) 10 is passed through a prism 12. An optical assembly (not shown) is optionally provided to focus emission 10 to the prism 12. As an alternative, a diffraction grating (or beam splitter) is used instead of prism 12. Prism 12 separates the spot color emission 10 into its component color spectrum 13a-n, where n is a maximum number of possible color components. A detector 14 such as a CCD array detects the component colors 13a-n. Of course, the detector 14 can be aligned with prism 12 (and optionally calibrated) to insure maximum detection quality.

A “signature” is determined for a subject spot color based on the color components 13a-n. A signature, e.g., as shown in FIG. 1b, represents the various spot color spectral components. In one embodiment, the signature includes the intensity of the various spot spectral color components. In another embodiment, the signature includes the relative percentages of the individual spot color components. In still another embodiment, the signature represents the spot color spectrum, with the component colors indicating the presence of the particular component.

Once determined, a spot color signature is preferably compared against an expected signature. This comparison is used to determine authenticity. Consider a counterfeited document or product package, in which the original was printed with a spot color. In many counterfeiting operations, a spot color is converted to a CMY, CMYK or RGB approximation of the spot color. Such an approximation will yield a different color signature. A comparison of a counterfeit signature against the expected signature reveals the counterfeit. Accordingly, identification badges, identification papers, travel paper, pictures, logos, security papers, passports, product labels and packaging, visas, etc., can be printed with a spot color to render additional security.

Environmental Triggers for Use With Digital Watermarks

Previously mentioned U.S. patent application Ser. No. 09/571,422 discloses various methods and systems for controlling computers and linking to Internet resources from physical and electronic objects. Parent application Ser. No. 10/012,676 discloses techniques to combine collateral data with other data to select a web site.

A response can be varied based on a user's environment. For example, a user seeking to access a target website presents a watermarked item to a kiosk-based watermark detector. A typical kiosk includes an input device (e.g., web camera, scanner or digital camera), a computer with Internet or other network communication hardware and drivers (modems, Ethernet cards, network cards, PMC cards, etc.), an Internet browser (or other communications interface), monitor and digital watermark detection and decoding software. The kiosk captures an image of the digitally watermarked item via the input device and the watermark detection software extracts a digital watermark identifier. The kiosk preferably communicates the extracted identifier to a central router via the Internet. The central router communicates information (e.g., a URL) to the kiosk to redirect the kiosk's browser to a target website that corresponds to the digitally watermarked item.

The kiosk preferably designates that the user is accessing the target website via a kiosk. In one embodiment, the kiosk (or central server) appends environmental data (e.g., a codeword, bits, flag, or other data) to the URL provided by the central router. The environmental data indicates to the target website that the user is communicating from a kiosk. The target website searches the URL for the appended environmental data. Once extracted, the environmental data is used to access a corresponding kiosk-oriented web page. (See Assignee's U.S. patent application Ser. No. 09/864,084 for a discussion of appending URLs, etc.). In another embodiment, the kiosk appends environmental information to an extracted watermark identifier. The appended, extracted watermark identifier is then relayed to the central router. The central router matches the appended identifier to corresponding information (e.g., a URL). The information is then communicated to the kiosk to redirect the kiosk's browser to a corresponding website or other network resource that is custom-designed for the particular environment (e.g., kiosk, mobile or home computer). In still another embodiment, the kiosk communicates environmental information to the target website and/or central server to indicate the appropriate environment.

Similarly, a home or personal computer appends (or otherwise communicates) environmental data either to a URL or to a watermark identifier to signify that the user is accessing the website via a home or personal computer.

Now consider the following example. A consumer wanders into a department store to purchase lipstick. The lipstick packaging includes a digital watermark. The consumer presents the lipstick to a store kiosk, which links the user to a corresponding target website. (The kiosk communicates environmental data to signify that the user accessing the website from a kiosk.). The website response may be to highlight all of the shades and/or textures available by the lipstick manufacturer, or to provide other information about the lipstick. The consumer purchases the lipstick. The consumer then decides to try her hand at the lipstick's linking capacity via a home, mobile or personal computer. The home, mobile or personal computer communicates environmental data to indicate that the user is access the website from a home, mobile or personal computer. This time, the consumer is presented with different information when the same lipstick package is shown to an input device communicating with the consumer's home or personal computer. For example, the consumer could be presented with complimentary products that match the shade of lipstick already purchased by the customer.

Coupons and Digital Watermarks

A recent Internet development is the so-called “e-pages.” This e-page service operates like traditional yellow pages, but over the Internet. They allow users to print coupons and carry them to the issuing establishment for redemption. Coupons are generally expected to cost very little per unit, so the idea of attaching a $1 price tag onto each coupon printed, e.g., for a Dominos Pizza $1 discount, would be very expensive.

An improvement is found with digital watermarking. In particular, a digital watermark identifier is embedded in a downloadable coupon. The identifier is used link the coupon to discount or redemption information, or to verify that the coupon is valid. Such linking can be performed with the techniques disclosed in Assignee's U.S. patent application Ser. No. 09/571,422. An example of suitable client software is Digimarc's MediaBridge product, available at www.digimarc.com or from Digimarc Corporation headquartered in Tualatin, Oreg., USA.

A consumer (or user) accesses an Internet or other coupon-distributor site to download (or acquire) a printable coupon. Prior to printing a coupon, the coupon distributor (e.g., website) preferably acquires demographic and/or identity information, e.g., through initial registration and login. The user is preferably assigned a User ID in this process. The User ID is attached (or appended) to a coupon watermark ID, and optionally, to a customer ID (e.g., Dominos Pizza's ID) and a graphic file having a digital copy of a coupon to be downloaded and printed.

In one embodiment, a watermark ID is pre-assigned a monetary discount value (e.g., $1 off). This information is maintained by a central database. In another embodiment, the watermark ID, User ID, customer ID, or a subset of this information, is stored in the central database. The central database associates relevant discount or coupon information (e.g., a coupon value, expiration dates, etc.) with the watermark ID.

The appended watermark ID is embedded into the graphic file and the embedded coupon is communicated to the user's web browser for printing. Since the watermark ID is appended with the user's ID, the watermark ID is unique to that user—although the user may not even know that there is a digital watermark in the coupon.

At a customer's establishment (e.g., at Domino's Pizza), the user presents the watermark embedded coupon to an attendant (or to a watermark reading kiosk). A watermark reader scans the coupon in search of the embedded watermark. Once found, the watermark is used to link to the central database. The central database compares the watermark ID to its database entries to determine whether the coupon is authentic. Optionally, the database sets a flag (or populates a database field) to indicate whether the individual coupon has been previously used. A discount is given when the coupon is authentic, and optionally, not previously used. If not authentic, the identity of the coupon owner is known through the appended user ID.

An advantage of this system is its flexibility.

Watermark IDs can be repeated for different types of customers. For example, the same watermark ID can be used for Domino's Pizza and Blockbuster Video, since it is not likely that Domino's will accept a Blockbuster Video coupon. Coupon distributors (e.g., an Internet coupon distributor) acquire a “pool” of watermark identifiers (ID) from the central database. A coupon distributor then searches their watermark pool for an ID not previously used for a given customer or used in a given market segment (e.g., any Pizza Parlors). A coupon distributor can always acquire more watermark identifiers if they extinguish or use all of the IDs in their pool. As mentioned above, a coupon distributor can reuse a watermark ID for different customers, particularly if the watermark identifier is predetermined to represent a monetary discount. Thus, the per-unit cost of the watermarks is roughly proportional to the number of customers the coupon distributor owns.

Watermark Detectors

Many digital watermarking applications require a watermark reader equipped with a digital camera or other imaging sensor. An improvement to such readers is to provide a dual lens assembly to help mount a camera in a tight space.

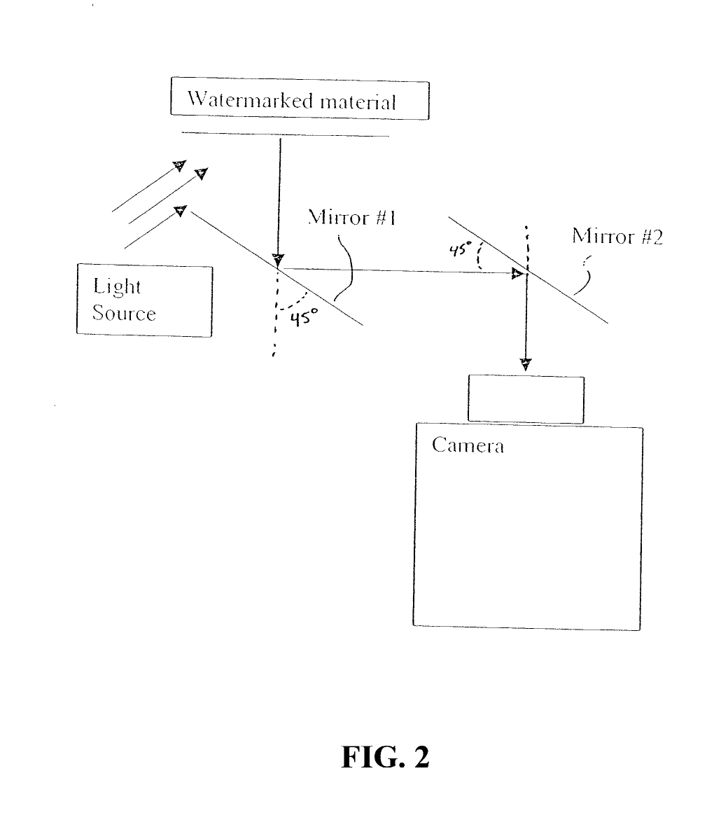

With reference to FIG. 2, an optical assembly allows a camera to be mounted on (or near) the same plane as the watermarked material being imaged. This assembly is particularly useful in cases where there is insufficient room to mount the camera in the more traditional “head on” orientation, due to the combination of the camera's housing and the need to allow for a focal distance, which, for example, can be about 5 inches.

This illustrated assembly uses two reflective surfaces, e.g., mirrors, to reflect light from the imaged watermarked material to the camera. The first mirror (#1) is preferably positioned at a 45-degree angle with respect to the watermark material. The second mirror (#2) is preferably positioned to be parallel with the first mirror. (Using a single mirror assembly is an alternative embodiment, which may yield some positioning advantages. However, a single mirror assembly causes image reversal and requires software reorientation prior to watermark detection. While not a fatal consideration, a single mirror assembly may require additional processing time. This reversal may also cause performance degradation and requires additional software controls, complicating the setup of the watermark detection software.). By utilizing a second mirror to counteract the reversal of the first mirror, two objectives are achieved. First, the reversal of the image by in software is not needed. Second, it allows additional flexibility in the positioning of the camera. A light source is optionally positioned to illuminate the watermarked material. Alternatively, many cameras have built in a light source.

The distance path from the watermarked material to mirror #1—to mirror #2—to the camera lens should be at (or near) the focal distance of the camera. In one embodiment, the focal distance for optimal watermark detection is in a range of 3-7 inches.

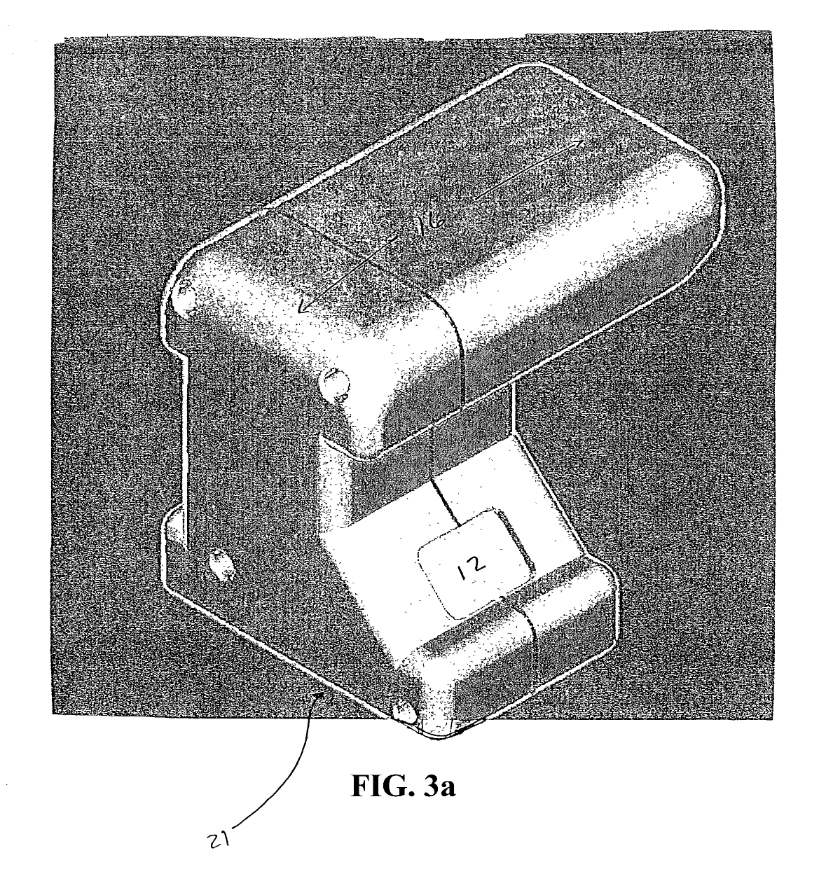

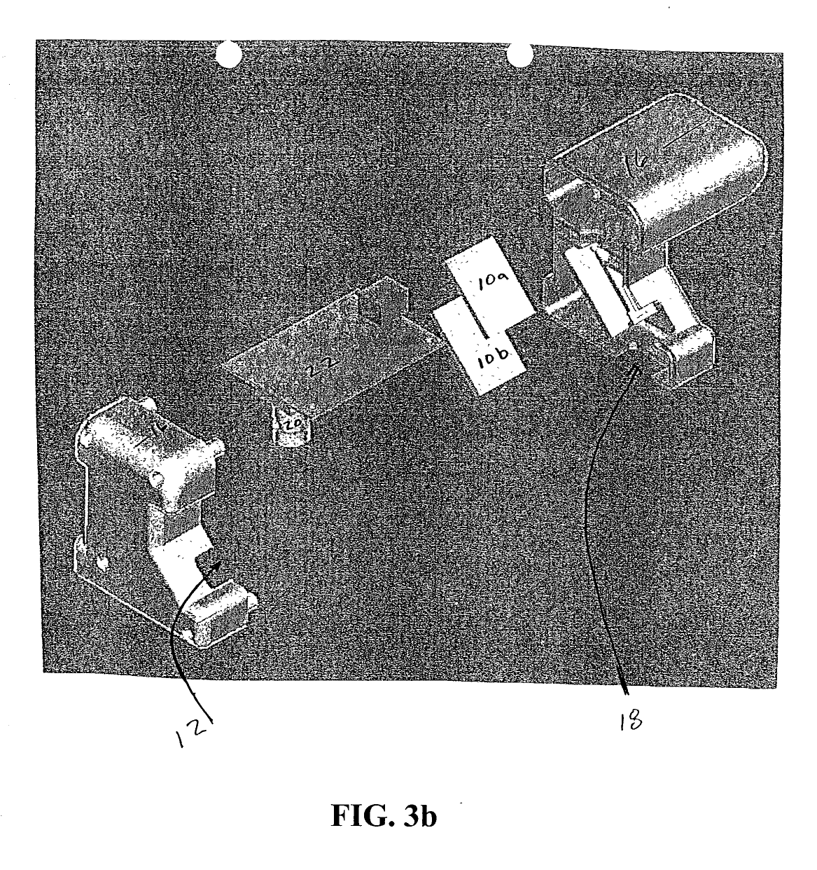

An alternative watermark reader is described with reference to FIGS. 3a and 3b. The illustrated reader is a handheld device, which is placed above a watermarked item. A user positions the reader with handle 16. The reader includes a lower opening or window 18 through which an image of watermarked material can be captured. The illustrated watermark reader includes dual reflective surface 10a and 10b (FIG. 3b). The reader provides a view window 12, which allows an operator to position the reader over an area to be scanned by the watermark reader. The window 12 can optionally be covered with reflective surface, e.g., a ¾ reflective surface. Such a surface allows an operator to see through the surface, but prevents ¾ of the outside light from entering. The illustrated watermark reader including an optical sensor 20, such as a black/white image sensor. For example, the sensor may include characteristics such as an 8-bit gray-level capture, with 640×480 resolution. The image sensor optionally has a lens adjustable to 450, 600, or 800-1200 dpi. Of course, these characteristics can be changed without deviating from the scope of the present invention. The image sensor, along with image processing circuitry, can be packaged on a circuit (or component) board 22 by vendors such as OmniVision Technologies headquartered in Sunnyvale, Calif., USA. The watermark reader can also include a light source, such as an LED. The path length from the watermarked material to the first mirror 10a—to the second mirror 10b—to the image sensor is preferably equal to or near the focal length of the camera. Of course, the watermark reader can be shielded to help comply with FCC requirements.

As an optional feature, the illustrated reader includes a shutter or image capture trigger (button). The trigger can be located on the lower side 21 (e.g., the window 18 side) of the reader. A user activated the trigger by pressing down on the handle 16—which applies pressure from the reader on the trigger. An image is captured with the ease of a mouse-like click. Alternative embodiments place such a trigger on or near handle 16. In another embodiment, the camera 20 continuously captures images, e.g., like a web camera.

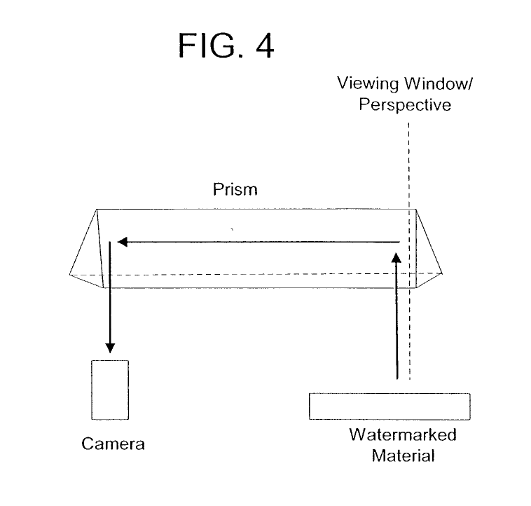

Still another watermark reader is illustrated with respect to FIG. 4. Here, a prism is used as a communications channel. The imagining path through the communications channel is illustrated with arrows. An advantage of this system is that a view window is positioned directly above the watermarked material, allowing for precision scanning of the material. Of course, a light source can be provided to illuminate target watermarked material.

Secure Websites

Embedded machine-readable code can be used to link to an Internet site or other network resource. Consider a document that is embedded with an identifier. Such an identifier can be detected from optical scan data, e.g., data collected from a scanner, digital camera or web cam. Once detected the identifier is communicated to a router. The router includes (or communicates with) a database storing a plurality of URLs. The URLs are indexed via watermark identifiers. The extracted identifier is used to interrogate the database to locate a corresponding a URL. The URL is used to direct a user's web browser to a target website. Commonly assigned U.S. application Ser. No. 09/571,422, filed May 15, 2000, discloses many examples of linking techniques. In one embodiment, the watermark reading and linking functionality is enhanced with Digimarc MediaBridge software, available at www.digimarc.com or through Digimarc Corporation, headquartered in Tualatin, Oreg., U.S.A.

Consider an implementation where a URL points to confidential material, or to a privileged website (e.g., a website accessible through watermarked documents.). An owner or company typically seeks to protect such information, that is, they do not want links to the site emailed or book marked. Nor do they wish to have search engines indexing the site. In such cases, it is advantageous to restrict access to the website, allowing access only via physical possession of a corresponding watermarked document. (In this application, a “document” can be an identification card (e.g., a driver's license, student ID, photo ID, identification document, or passport, etc.), a value document (e.g., a banknote, stock certificate, or other financial instrument), a legal document (e.g., a will, trust, contract, court proceedings, company records, etc.), confidential documents, a trading card (e.g., baseball card, other sports card, game card, character card, etc.), a magazine/newspaper image or article, advertisement, promotional, flier, stationary, envelope, brochure, letterhead, product package, wrapping or label, candy or food wrapper, a credit card, a product manual, business card, bank or credit account card, printed document, picture, image, photograph, graphic, illustration, registration card, or virtually any other type of document. In some embodiments, a document includes a physical object such as a coffee cup, napkin, fabric, clothing, menu, soda pop can, jewelry, hardware, souvenir, etc.). Assignee's U.S. patent application Ser. Nos. 09/853,835 and 09/864,084 disclose many techniques for securing a privileged website.

An improvement for securing a privileged website is to periodically (or randomly) change the URL associated with a watermark identifier. A central router includes a database populated with URLs. The URLs are indexed according to watermark identifiers. In this improvement, a document is embedded with a watermark identifier. The identifier is static, e.g., it remains unchanged. However, a URL associated with the identifier is periodically changed. The router database is updated to reflect this change, so the document continues to serve it's linking function. Saved links, bookmarks, forwarded links and search engine indexes rapidly become obsolete when the URL is changed. The security of the site is controlled by the life of a URL. Preferably, the lifespan of such a URL ranges from a matter of seconds to a matter of several weeks. To the holder of the document, the change is transparent—since the holder continues to obtain access through their digitally watermarked document.

Imagine a company or organization wants to have a site accessible through Digimarc MediaBridge (via the Grand Central server), but wants some level of security for the site. That is, they don't want links to the site emailed around, they don't want search engines indexing the site, etc. For example, Integraf may send out a brochure with “exclusive secure” access to an Intergraf 2001 exhibitor's web site. The site has some long obscure URL such as www.trytotypeinthislonnngobscureurlwithoutmakingamistake01112344567.com. The brochure, of course, is watermarked with an ID that links to the site (through Grand Central). Now imagine that the URL actually changes periodically. Grand Central knows of the change so that the brochure continues to serve its function, but saved links, forwarded links and search engine indexes become rapidly obsolete. The security of the site is controlled by the life of a URL. It could be varied from one second to one week depending on how sensitive the owning organization is. To the holder of the brochure (or other access document), the change is transparent, since the GrandCentral database changes the destination URL in synchrony with its movement by the organization.

This aspect of the present invention is not limited to rotating URLs. Indeed, in one embodiment of this aspect of the present invention, sensitive documents (e.g., such as confidential briefings, company or country secrets, or other materials) are linked to additional information via a watermark identifier. The additional information is available on an intranet, extranet or other network system. A file name, storage site or network address pointing to the additional information is changed as discussed above. Accordingly, the additional information is afforded an additional layer of security.

In most cases, a robust digital watermark is embedded a document as the identifier (e.g., the linking data). (The term robust implies that the watermark typically will survive a copy/print process, signal processing, etc.). As an alternative, however, the identifier can be embedded with a so-called fragile watermark. A fragile watermark is designed to be lost, or to degrade predictably, when the data set into which it is embedded is processed in some manner, such as signal processing, compression scanning/printing, etc. A watermark may be made fragile in numerous ways. One form of fragility relies on low watermark amplitude. That is, the strength of the watermark is only marginally above the minimum needed for detection. If any significant fraction of the signal is lost, as typically occurs in photocopying operations, the watermark becomes unreadable. Another form of fragility relies on the watermark's frequency spectrum. High frequencies are typically attenuated in the various sampling operations associated with digital scanning and printing. Even a high amplitude watermark signal can be significantly impaired, and rendered unreadable, by such photocopying operations. (Fragile digital watermarking technology and various applications of such are even further disclosed, e.g., in assignee's U.S. patent application Ser. Nos. 09/234,780, 09/433,104, 09/498,223, 60/198,138, 09/562,516, 09/567,405, 09/625,577, 09/630,243, 09/645,779, 09/689,226, 09/689,289, 09/689,293, 60/232,163, 60/247,389, and 09/898,901.).

A fragile watermark will prevent copies of the watermarked document, e.g., since if the fragile watermark is copied the embedded identifier will be destroyed or significantly degraded. As a further alternative, a document includes both a robust and fragile watermark. The robust watermark includes the identifier and the fragile watermark can be analyzed to detect a counterfeit or copy document. In this alternative, the fragile watermark must be detected in order for a user's application to perform the linking functions discussed herein. In this way the website “hides” as the URL changes and only original documents can complete the link from paper to online information.

Another security feature is based on fingerprinting (or hashing or signing) technology. Assignee's U.S. Provisional Patent Application No. 60/263,490 discloses various methods and applications for fingerprinting. As will be appreciated by those skilled in the art, a fingerprint is an algorithmic or mathematical representation of an image or other content item. A fingerprint is derived from the content item itself. Preferably, a fingerprinting (or hash, signature, etc.) technique converts (or transforms) a content item into a numerical value (e.g., an identifier). Take an image, for example. A fingerprinting algorithm yields a unique identifier of the image. This fingerprint identifier is used in place of a watermark identifier discussed above. In this embodiment, however, the fingerprinting algorithm used to calculate an identifier is changed. The content item remains static, yet a resulting fingerprinting algorithm becomes dynamic. A routing server can be updated to reflect these changes.

A generalization of all of this is that each and every object can have its own, generally inaccessible, rich source of attached information and inherent interactivity. This could be an entire platform all to itself.

Copyright Protection Recent controversy has emerged regarding search engines, e.g., powerful searching tools (or so-called “spiders”) that crawl the web in search of content to index. Spiders often make copies of content (images, articles, audio, etc.) that they encounter. These copies are frequently archived in a search engine's database for display in search result lists. (A search engine will typically reduce an encountered image to “thumbnail” size.). Most often these copies are made without authorization from the creating artist. And artists believe that this is unfair—if not a violation of the copyright laws. They argue that search engines are essentially becoming “clip-art services” that give artists no credit or revenue. Artists argue that a search engine should at least link people directly from a thumbnail image to the artist's Web page and should not allow copying of the image. (For a further discussion of these copyright issues see “Do Search Engines Expedite the Theft of Digital Images?” by Lisa Guernsey, Sep. 6, 2001, as printed in The New York Times, hereby incorporated by reference.).

Digital watermarking technology can provide a solution for copyright owners. Assignee's U.S. patent application Ser. Nos. 09/620,019, 09/574,668, 09/525,865, 09/636,102 teach various methods of embedded data conveying copy restriction information. For example, a watermark may include plural bit data to indicate “do not copy,” “copy once only,” “restricted copying,” etc.

Prior patent documents by the assignee of this patent application describe systems and methods of automated searching and watermark screening of media object files on computer networks like the Internet. See U.S. Pat. No. 5,862,260. The software used to perform automated searching and compiling of Internet content or links is sometimes referred to as a web crawler or spider.

As extension of the watermark based information retrieval described in U.S. Pat. No. 5,862,260 and marketed by Digimarc Corporation, watermark decoders can be employed in a distributed fashion to perform watermark screening and counting of watermarked media objects on networks, including the Internet. In particular, watermark decoders can be deployed at a variety of locations on a computer network such as the Internet, including in Internet search engines that screen media objects gathered by each search engine, network firewalls that screen media objects that are encountered at the firewall, in local area networks and databases where spiders do not typically reach, in content filters, etc. Each of these distributed decoders functions as a spider that logs watermark information as described in this document and those incorporated by reference. Examples of the types of information include identifiers decoded from watermarks in watermarked media objects, media object counts, addresses of the location of the media objects (where they were found), and other context information (e.g., how the object was being used, who was using it, etc.). The spider threads, in turn, send their logs or reports to a central spider program that compiles them and aggregates the information into fields of a searchable database. (See Assignee's U.S. patent application Ser. No. 09/636,102).

An improvement includes providing a digital watermark in images (and other content) that are posted on or otherwise made available via the Internet. The digital watermark preferably includes a “Do Not Copy” bit (or bits—hereafter a “copy indicator”). An artist selects a desired level of copy control during or before the watermark embedding process. The copy indicator serves as a trigger, e.g., signaling to a search engine that a subject image is not to be replicated or is to be replicated only under certain conditions. One condition is that a search engine is able to replicate the image and post a thumbnail replica of the image, but must provide a link to the artist's (or other) website. Another condition is that a search engine is not allowed to make a copy, but can provide a text description or a link to the subject image. Still another condition is that copying is permitted only after express permission is obtained from the artist. Of course still other conditions can be communicated with the copy indicator.

In one embodiment, a search engine examines an encountered image (or other content) for a digital watermark. Once found, the watermark is decoded to obtain the copy indicator bit (or bits). The search engine then handles the image in accordance with the copy indicator.

In another embodiment, an artist's website controls access to an image based on the copy indicator. For example, the website communicates the image or image details only if permitted by the copy indicator bits. Similarly, a search engine can regulate user access according to the copy indicator.

Photography and Portraits

Embodiment 1—Wedding/Professional Portrait Markets

Photographers are excerpts at taking pictures, but often tire with the administrative details associated with printing and marketing their photos. The first embodiment provides systems and methods to allow a photographer to focus on taking pictures, while outsourcing the printing and reprinting process. Photograph proofs for clients are digitally watermarked. Similarly, final prints are also digitally watermarked. Photo stores are equipped with digital watermark readers, e.g., including Digimarc's MediaBridge software. These photo stores typically have service component of storing large amounts of image data for immediate re-orders. In the preferred implementation, the clients take the digitally watermarked proof and prints and make an order by simply showing the watermarked prints or proofs to the photo store's watermark reader. An interface (GUI) cues up a job order, and can optionally instruct the photo store's high quality printer to print the order. A database helps manage ordering to ensure that both the photographer and the photo shop receive payment for their services. Years later, requests for reprints are similarly processed, particularly if the client establishes a multi-year data storage service agreement (e.g. $10/year per wedding) with either the photo store or the proprietor of the database. Optionally, the photographer maintains the photos. In either case a centralized database tracks which photographer should get the payment. (See assignee's U.S. Provisional Patent Application No. 60/300,649 for a related discussion.).

Embodiment 2—Detailed Wedding Example

(In this embodiment, it is assumed that a photographer is just beginning to move toward the basics of digital photography, but is still largely film based.).

Joan is a wedding photographer. She shoots everything on 35 mm film and then prints her negatives on standard photograph paper (e.g., Kodak paper). She has only recently started to play with scanners, software editing tools (e.g., Adobe's Photoshop) and “medium end” color printers. She still thinks digital is still a few days away for her. Her trusted high-end photo store is experimenting with a new digital watermarking program just for wedding photographers, affectionately branded as the “You take the pictures, we'll send you the checks” program. Joan decides to try this program on her next shoot, knowing that her back up is to simply run her usual film-based routine.

Joan shoots 14 rolls at the Shnackenburgers' wedding. The photo store processes the negatives as usual. But rather than optically printing the contact sheets, the negatives are instead sent through a standard scanner (e.g., at 1200 dpi) and are digitized. Each print is individually digitally watermarked. Each individual image is embedded with a unique watermark ID, and a central database and/or the local photo store associates the unique ID's to Joan, the wedding, the roll number, the photo number, and/or anything other identifying information. (The original negatives are then stored in a safe place or given back to Joan.).

Joan reviews all the images on computer terminal at the photo store or at her studio. She rejects some the photos as not being worthy to share with her clients. The rest Joan has printed onto contact paper, generally about 20 or so proofs per contact sheet, for her own review and ultimately for review by her clients. Each of the printed contact proofs is printed with an imperceptible (or nearly imperceptible) digital watermark. As mentioned above, the proofs are individually identified with a watermark ID.

Joan either meets her clients at the photo store or at her studio. They review the contact proofs. The clients hem and haw, but slowly choose which photos they want, how many, what sizes—the usual selection drill. To finalize her client's selections, and instead of using a standard grease pencil with obscure markings, Joan simply holds the selected contact proofs up to a watermark reader. The watermark ID is extracted, the photo/watermark database is interrogated, and a photo selection GUI knows which picture is being selected via the watermark identifier. Joan or her client selects the number and sizes through the GUI. The watermark GUI software is preferably forgiving (e.g., “Press OK if this is the correct photo” as the computer screen highlights the photo it is displaying from the camera view). Joan and her clients build up the whole order list and a tally is presented to them through the interface. The photo store then takes it from there—printing the request order for the clients.

But, there are many more benefits and variants. After Joan finalizes the first set with the clients, she encourages her clients to take the proofs and show them to as many guests, friends and family members as possible. If they want to order more, they have many simple options. They can come back to the store and simply use a store watermark-reading kiosk. Or if any of their friends have watermark reading software (e.g., Digimarc's MediaBridge software) at home with a camera, they can even order from home.

When the prints are printed, if indeed they have been created from the scanned negatives rather than optically from the negatives (which is anticipated to be the case over the next few years as cheap scanners and storage move to 1800 and 2400 dpi scan/store), then years later, the Shnackenburgers and their friends can simply come into the store for more prints by holding up either the prints or the saved contact proofs. Joan's address is on file at the photo store, and every X amount of dollars ordered generates a check for Joan. Likewise, home ordering is possible even for years to come in the future.

Embodiment 3—Detailed Wedding Example

In this embodiment, a photographer is a slightly early adopter of digital cameras and processing.

Betty is the wedding photographer. She has already made the switch to all digital cameras (expensive up front, but well worth it in work flow savings, ease of storage, etc.). Betty has a higher volume clientele and she is actively looking for more ways to automate, hire assistants, and to further simplify her business. When Betty is done shooting a wedding, she uses the same program above as described in Embodiment 2, but all she does is a quick digital review of the images, and simply mails (or e-mails) out proofs to her clients. Betty encourages her clients to simply go into the photo store, which has the necessary watermark detecting software, and to make their own ordering selection.

Other Wedding Notes

A photographer clearly has much to gain in these embodiments listed above. Likewise a consumer, if indeed they can have more freedom to choose what they want, get more of their friends/family to choose, and always have the ability to get more. The photo store can charge for facilitating client/photographer meetings, but much more importantly, provide a digital storage service and hopefully sell and resell a lot more photographs.

Embodiment 4—Commercial Professional Photographers

This is a similar story in view of the above embodiments. A photo store initially (and thereafter through sales of negative scanners for high-end dark rooms) begins to get professional photographers to start watermarking their scanned negatives. These scans are used for all the traditional “contact sheets” and images in a normal workflow process. This process hastens the existing trends toward storing away pristine negatives only for finals, while using the watermarked scans for all workflow steps. The watermark ID registration location can move quickly toward a simple, centralized digital asset management (DAM) repository. Through a watermark enabled camera on the desktop of anyone apart of the normal workflow, and any physical print they have can instantly access not only the original, but oodles and oodles of workflow notes and logs reflecting who has done what with that particular image.

Here again, there is a benefit that even after a given image is eventually printed and even published (and in most cases where things such as “resolution” and “scale” are reasonably normal), holding a digitally watermarked image or even a montage up to a normal camera can still access a photographers or ad agencies or stock house's DAM archives.

Embodiment 5—Scientific Imaging

The notion of linking photographs to scientific context, experiments, and theory is intriguing. Especially where any given photo/image routinely has a watermark with a “link to related photos and articles.” Doubly interesting is that every physical print of that photograph has the same watermark-based inherent links. Now imagine that a scientist is reading an article on strange-boson collisions. To retrieve additional or related information, the scientist simply presents the article to a camera and many photos from the same or related experiments pop up on a web page. This can be accomplished by watermarking the article and printed photographs with unique identifiers (e.g., the “link”). The articles/photographs are entered into a database according to their identifiers. In one embodiment, a scientist or author has an opportunity to enter key words (or other metadata) to describe the photo, experiment or article (e.g., in this case “strange,” “boson” and “collisions”). The article/photograph, via its watermark identifier, is then linked to other photographs, articles, etc. with the same or similar key words.

Identification Cards

In Assignee's U.S. patent application Nos. 5,841,886 and 6,389,151 we disclose an identification card that is enhanced with steganographic encoded information. The encoded information correlates photographic, bibliographic and/or biometric information with the card holder.

An improvement for these types of identification cards is to add a so-called fragile watermark to the identification cards. As mentioned above, a fragile watermark is one that is destroyed or degrades predictably when the data set into which it is embedded is processed in some manner, such as signal processing, compression scanning/printing, etc.

Security of ID cards is enhanced since even high quality replications of an ID card will not include the original fragile watermark. Hence a counterfeit is determined by the absence or degradation of the fragile watermark. In one embodiment, a robust watermark carries or identifies personal information, while the fragile watermark is used to help determine authenticity. If the fragile watermark is not recoverable in its original form, it is considered a counterfeit.

Removing Noise From a Signal

An improvement is now disclosed which further enhances the robustness of a video watermark. The improvement is based on the understanding that encoding removes independent noise, especially high frequency components.

In each noise (or image) tile, rather than making every watermark bit independent, the inventive improvement holds every watermark bit for a 2×2 or 3×3 tile block. If that noise tile structure survives but is visually not pleasing, the tile is smoothed with a hamming (or equivalent) window.

Another improvement is to take each standard independent noise tile, low pass filter the tile and then renormalize its energy before using it in a video watermarking method.

Audio Embedding

One inventive improvement involves embedding a digital watermark signal in an audio file or segment. The embedded digital watermark can be inserted in a precise audio location to mark a segment of interest. Or an audio file can contain multiple watermarks (or a redundant watermark every given x seconds). Each watermark preferably includes a unique identifier; or the presence of a redundant watermark serves as a “mile marker” or counter. In this way, the watermark provides an index for the audio segments or file. This technique is beneficial for sound technicians, commercial users, or any other organization that may wish to index an audio file. Once an audio segment is watermarked, a watermark identifier is searched for (or the watermarks are “counted” to find the right audio segment), instead of listening to an entire audio file to find, e.g., a particular 5-second segment. Preferably, the watermark search is conducted digitally, which significantly reduces the search time. This method also provides beneficial tracking information in the event that the audio signal is found in an unexpected distribution channel or location. In this case, the watermark can include a unique identifier, which is associated with a data record in a database. The data record includes information such as audio source, parties involved, authorized distribution channels, security levels, etc. Once extracted from the audio segment, the identifier is used to interrogate the database.

Traffic Monitoring

Another inventive improvement deals with traffic or vehicle monitoring. A vehicle is marked with a digital watermark. The marking can be accomplished in many alternative ways. For example, the digital watermark can occur at the manufacturer or auto body shop, in which the vehicle's hood, roof, and/or trunk is embedded with a digital watermark during the painting process. Since many auto-painting processes include automated multi-jet sprayers—analogous to common desk jet-printers—paint droplet positions (or intensity, gain, etc.) can be subtlety varied to embed a digital watermark. Or a laminate layer can be applied over the rear or front window. The laminate layer preferably includes a pattern that is recognizable to watermark decoding software, but is imperceptible to human observation. The watermark (including a laminate layer watermark) can optionally include IR or UV inks, dyes, or elements, which emit in the IR and UV spectrums respectively. The IR or UV emission can be analyzed to detect the digital watermark.

The vehicle can then be monitored from a satellite, other aerial platform, or by a land-based camera. For example, a satellite captures a high-resolution image of the vehicle. The image is scanned by watermark detecting software to detect and decode the watermark. If the watermark contains an identifier, it can be logged in a database, along with the time and vehicle location. These techniques can be used to monitor congestion in heavy city traffic, or to follow the secret exploits of a lover. (Since there are no “electronic” signals given off from a digital watermark, a standard “bug” sweep by the lover will not find the watermark like it would for an RF or IR device.). Of course, those interested in vehicle surveillance can employ these techniques.

Instead of applying a watermark at the manufacture or auto shop, a vehicle can be alternatively marked on the street or in the field. Consider a paintball-like capsule that includes specialized inks or dyes. For example, inks and dyes have recently emerged with unique fluorescent properties. Some of these properties allow for variable fluorescence (or emission) decay times. Typical decay times can be varied from less than a microsecond to tens of milliseconds and more. These inks and dyes (both hereafter referred to as “ink”) also include unique emission characteristics, such as emitting in a particular frequency band, which allows for frequency-based detection. Other unique characteristics include varying the frequency of light needed to activate the ink and the color of the ink's fluorescence. These characteristics can be variously combined to produce customized ink. These types of ink are typically excited with UV light and emit from ultraviolet (UV) to infrared (IR) wavelengths. These inks are generally invisible when illuminated in the visible spectrum. Such inks are available from PhotoSecure in Boston, Mass., USA, such as those sold under the trade name of SmartDYE™. See SPIE's September 2001 OE Magazine, pages 8-9, written by M. Brownell (“Counterfeiters Dye Over Security Measures”), hereby incorporated by reference, for a further discussion of such inks.

The ink capsule is thrown on or otherwise applied to the vehicle. The vehicle is illuminated with UV (or IR) light, and the ink emits in a certain frequency band, or its emissions decay within an expected time frame. (Notice that normal lighting conditions typically include UV components, which may suffice to excite the UV (or IR) inks.). Monitoring can be accomplished by analyzing such emissions. Another field-marking technique requires the application of a transparent (or color matched) “sticker.” The sticker preferably includes an embedded digital watermark. The watermark is detected with the above-described techniques. In still another case, a laser or other etching tool is used to etch a digital watermark into a vehicle's paint.

Communication Authentication Digital watermarking can improve communication security. For example, take an audio, video, text or image message that is transmitted from a business to its partner. The business digitally watermarks the message with a digital watermark. The digital watermark preferably includes an authentication code, which is optionally encrypted or further encoded. The partner scans a received message for the digital watermark. Decoding software/hardware detects and then decodes the digital watermark. Once extracted, the authentication code is compared with the partner's list of authentication codes. If the code matches, the message is deemed authentic, and the partner can rely on the message with a high degree of confidence. Similar benefits can be achieved in other message communication environments, such as between airplanes and ground control, banks, financial institutions, and an operational command center (or dispatcher) to field units, etc. U.S. Pat. No. 6,278,781 and U.S. patent application Ser. No. 10/177,650 disclose related concepts. Each of these patent documents is herein incorporated by reference.

Object Authentication

Hidden digital watermarks provide a mechanism for authenticating a physical object. This authentication mechanism can be layered with other security printing features, such as Intaglio printing, printing with UV and IR inks, and security devices, such as holograms, RF ID tags, magnetic inks, smart cards, etc.

A digital watermark embedding process makes subtle modifications to an image printed on the object or to the surface microtopology of the object that embeds a machine-readable code that is substantially imperceptible to a human viewer. One particular way to integrate digital watermarks with other security features is to divide the surface area of the object into blocks and embed a unique watermark message in each block. This unique watermark message carries a block identifier that provides the watermark detector with information about the location and/or type of security features on the object.

In one implementation, the digital watermark is embedded in N-by-N blocks, where N is an integer number of pixels from about 100 to 500 at a spatial resolution of about 75 to 300 dots per inch (dpi). The digital watermark in each block has a signal attribute that is used to geometrically align (or calibrate) the image blocks in a digitally scanned image of the object. One particular example of this calibration signal attribute is a constellation of signal peaks in the autocorrelation, Fourier, or some other transform domain.

The digital watermark in each block also carries a block identifier, and optionally other message fields. The message is error correction encoded using repetition and other block/convolution error correcting codes (e.g., turbo codes, BCH codes, convolution codes, etc.). The message is modulated with a carrier signal that disperses the signal pseudo-randomly over the entire block. This modulated carrier is then added to the host image block in the spatial or a selected transform domain.

To authenticate the object, an inspector scans the object with a digital imaging device such as a scanner or camera, which captures digital images of the object. The detector then performs peak detection for the calibration signal peaks, and correlates the detected peaks with reference peaks to determine the orientation (e.g., rotation, scale, translation of the watermarked blocks). The block identifiers are then decoded from each block by demodulating the message from the known carrier signal and error correction decoding the message symbols, including the block identifiers.

Having extracted the block identifiers, the watermark detector passes them to an authentication module. The authentication module uses a look up table to map the block identifiers to a corresponding authentication process. The authentication process indicates the type of security feature and the location relative to the block to analyze in the digital image.

Multiple security features can be indexed and analyzed in this fashion. The following sections detail some of them, and many others may be included. One security feature is a fragile watermark as discussed above. The fragile watermark in this case is designed to degrade when the object is photocopied, or scanned and re-printed. The authentication module identifies where to look for the fragile watermark in the digital image, and possibly other related authentication parameters, such as fragile watermark thresholds used to analyze whether the measured bit errors or signal power of the fragile watermark indicate that the fragile watermark has been sufficiently degraded to consider the object a copy. The fragile watermark may simply be un-readable in a copy, or may be readable, yet carry a message with measurable bit errors, or have measurable signal power degradation as set forth in U.S. patent application Ser. Nos. 09/938,870, 09/840,016, 09/689,226, and PCT Application No. PCT/US99/01296. The fragile watermark may be embedded at a higher frequency and/or embedded in conjunction with a robust watermark to which it can be compared to analyze its degradation. Further, the authentication module may specify a key indicating pseudorandom image locations where the fragile watermark is expected to be found.

Another security feature is a spot color with particular attributes that are difficult to re-produce using conventional scanners and printers expected to be used by counterfeiters. In this case, the authentication module uses the block identifier to provide the location and spot color attributes to be analyzed for authenticity. It then examines the block area of interest for the spot color, for example, using a spectral analysis or histogram analysis of the color attributes.

Another security feature is a digital watermark hidden in a covert channel, such as a watermark message embedded in the IR or UV range. In this case, the authentication module uses the block identifier to locate block locations and possibly decoding parameters (such as a watermark key) used to detect the watermark in the IR and/or UV range. Similarly, digital watermarks may be hidden in different color channels in different blocks. In this case, the authentication module provides the color key indicating where the digital watermark is hidden. In one implementation, for example, the color key specifies the color channel in which the watermark is embedded as a function of the color of the scanned color values from the object as in U.S. patent application Ser. No. 09/553,084.

Other security features include a hologram. In this case, the authentication module provides parameters used to authenticate the hologram feature, such as a key for decoding a scrambled message embedded in the visual information scanned from the hologram. In particular, embedding a watermark in an image, and then projecting that image into the hologram, may create the scrambled message. Alternatively, the scrambled message may be created by modulating the message with a PN sequence, mapping the resulting random number vector to image locations within the hologram, and then selectively de-metalizing tiny dots in the hologram's reflective metal layer to embed a scrambled image in the hologram. For more on this type of security feature, see U.S. patent application Ser. Nos. and 09/741,779 and 09/923,762.

Other security features include RFID tags, 1D and 2D bar codes, smart card IC chips, etc. In each case, the authentication module uses the block identifier from the watermark to look up parameters to authenticate these features. These parameters may include a key to decrypt machine readable information from the security feature, as well as keys used to check predetermined relationships between data stored in different features, or data stored in a feature and data printed on the object or provided by the bearer, such as a user ID, password, etc.

In sum, the block identifier provides a mechanism to integrate and automatically check a number of security features that are detectable/verifiable in a digital image scan of the object as well as to check other machine readable features or features printed on the object and/or supplied by an inspector or bearer of the document.

Watermarking Fabrics

Assignee has disclosed, e.g., in U.S. patent application Ser. No. 09/697,009, that fabrics and clothing can be digitally watermarked. Watermarks can be embedded through fabric patterns, printed designs (e.g., on a T-shirt), printed logos, etc. In one improvement, clothing is digitally watermark to include a unique identifier. The identifier is associated with an employee, such as aircraft maintenance personal, flight crews, or security guards, just to name a few. The digital watermark is extracted from the clothing with a digital watermark reader and the identifier is used to interrogate a verification database. The database preferably includes information such as pictures, fingerprint data, biometric data, etc. to be used to verify the employee's identity.

Variable responses

Assignee's U.S. patent application Ser. No. 09/571,422, filed May 15, 2000, discloses many applications and examples of computer and Internet linking techniques. In one disclosed embodiment, a computer is linked to an Internet resource. In another embodiment a computer performs an action when presented with a digitally watermarked object.

A user can be presented with a plurality of responses, such as linking to a URL, launching an e-mail, confirming an order, performing a local computer action, etc., in response to a single watermark identifier. The user then selects among the responses and the computer carries out the selected action. On a system wide basis, a database stores a plurality of responses in a data record associated with the identifier. When the identifier is selected, each of the responses (or a subset thereof) is communicated to the user's web browser or other communications interface.

A watermark ID registration database is able to accept multiple primary responses to a single ID. A customer may have determined that they would like to cycle through this list of multiple primary responses based either on specific conditions that are known to the ID detecting application (e.g., display all URLs, or execute the first response returned, or execute only after confirming with the user). Other conditions could include the environment of the detecting application (car, office computer, PDA, cell phone, loading dock, etc.); the past history of the consumer's access to this or related IDs; the access rights of the consumer with respect to the ID; or it could simply be a means for prioritizing the response put in front of the consumer based on marketing demographics and other information available to the detecting application.

Now consider an example where an audio watermark is detected in a car by the car's radio (or cd/tape/MP3 player or other watermark detecting device). The car's watermark detector locates a watermark ID and then communicates (e.g., wirelessly) the watermark ID a central database. The central database returns a list of valid actions/URLs to the car detector. The list may include, e.g., an MP3 download URL for the latest hit by the same group, a URL for the official fan web site, information on the Title, Track and Artist for the song, a URL for the song's recording company home page, and/or a URL for concert tour schedule for the group, etc.

The detector knows that it is in a car and that displaying web pages is either impossible or unsafe, so the detector uses it's environment to determine that of the list of received actions for the ID detected, it should display the Title, Track and Artist information. If the Detector is capable, it may even be able to download the latest MP3 format single from the group making it available for play in the car at the push of a button, or automatically.

Now consider an example where the same audio watermark is detected at home by a personal computer, instead of the car's detector. The watermark is extracted in the same manner described above, and the central server returns the same list of responses.

But since the detector understands that it is in a home environment on a PC, it may prioritize the responses differently, and allow the consumer to select amongst all of the choices or, perhaps, based on the consumer's past selections, it may automatically select one of the responses from the list for the consumer.

Of course, similar multi-response scenarios can be worked out for media content marked or identified with RFIDs, printed watermarks and video watermarks (as well as bar codes and other technologies that assign specific IDs to specific physical or media objects).

Watermarking Methods

Digital watermarks can include a code that controls device access, and particularly, controls rendering (display or printing) and transfer. In a network environment, firewalls can be equipped with content filters to check all files for watermarked content. Upon finding the content, the firewall blocks it, records where it came from and optionally records other details such as time or communications channel. Digital watermarks can be used to trace communications by embedding a code linked to the source or host content. Leaks can then be traced back to the source device or person.

Digital watermarks can be used to authenticate physical objects:

1. through the use of fragile watermarks (discussed above) that degrade when copied; and

2. through the use of hidden embedded data linked to other data or features on the physical object or in a database indexed by information on the card or embedded in the digital watermark.

Digital watermarks can be used as carriers of information. This is particularly helpful for consumer marketing, anti-counterfeiting or communications monitoring. As content is used or transferred, a user application or transferring device embeds an ID unique to that user or device. Additional data about the transaction can be embedded as well, or alternatively, an index can be embedded to a database that stores a record of the transaction. Later recordings can be traced back to the source. Embedders can be placed in telecommunications equipment or Internet nodes (including individual PCs). Elsewhere, watermark detectors are programmed to look for watermarks and record where they are found. Digital watermarks on physical objects, such as identity documents, can be used as access tokens for facilities and computer resources. Analysis techniques may be used to filter content and detect whether it has hidden data (e.g., a watermark), such as images that carry hidden data.

In some cases, all content from a particular source can be digitally watermarked, such as with an authentication watermark. Monitoring filters can then screen content for this authentication watermark and flag communications that are not marked. If someone tries to hide a message in this marked content, then the content will no longer be authentic and will be flagged for further investigation. Thus, if someone tries to send stegonagraphic messages, the stegonagraphic embedding process will alter the authentication mark in the host signal and flag it for follow up.

Paper can be pre-marked with a digital watermark. When distribution of this paper is controlled, the digital watermark can be used to trace where a particular document printed on that paper originated. The watermark can also include a rendering instruction that prevents reproduction of documents printed on that paper on all devices that can read the rendering instruction. Film also can be pre-marked (e.g., pre-exposed) with a watermark used for tracking, tracing and usage control as described above.

Techniques for Adding Digital Watermarks to Photographic Film Products

Assignee's U.S. Pat. No. 6,122,403 describes a technique for pre-exposing film with a digital watermark. When a picture is captured on this pre-exposed film the digital watermark and picture combine to form a composite image with an embedded watermark. This digital watermark may carry a variety of information for an array of applications, as noted in the U.S. Pat. No. 6,122,403 and other watermarking literature.

An alternative method for applying a digital watermark to a film product is to insert a filter in the optical path of the camera, where the filter carries (or embeds) the digital watermark. This filter alters the luminance of light passing through it such that it embeds a digital watermark in the image formed on the film (in a conventional analog camera) or image sensors (in a digital camera). In particular, the fluctuations in luminance form a hidden digital watermark. This digital watermark carries auxiliary information, such as information about the camera, the photographer, the subject of the photograph, a copy control command, a unique identifier, etc.

One can create such a watermarking filter component by lightly printing a screen in the pattern of the digital watermark, and mounting that screen on a glass filter. This process may be implemented similarly to manufacturing an anti-glare layer of a polarization filter. The filter is then either permanently mounted in the optical system of a camera, or is interchangeably mounted as part of an attachment, such as an interchangeably lens unit.

The filter changes the luminance of an image captured through it, and these luminance changes imperceptibly embed the digital watermark signal in that image. In a conventional camera fitted with this filter, this digital watermarking method allows a negative to be embedded at exposure time. Also, it enables watermark embedding without the use of an electronic system. If the filter is fixed to the camera, it prevents the camera from producing unmarked images. However, by making the filter interchangeable, digital watermarks with different messages (or unique identifiers) may be embedded in the images captured using filters with different watermarks or different messages (or payloads).

The digital watermark signal may be created using techniques described in this document, as well as in U.S. Pat. No. 6,122,403 and Assignee's U.S. patent application Ser. No. 09/503,881. See also Assignee's U.S. patent application Ser. No. 09/800,093, for a disclosure of images acquired through an LCD optical shutter, or other programmable optical device, that imparts an inconspicuous patterning to the image as it is captured.

There are alternative methods for applying a watermark by pre-exposing film. Conventional un-exposed photographic film consists of a length of substrate formed into a roll. It is useful to have efficient methods for pre-exposing the digital watermark along the entire length of the film so that individual frames in the film are individually watermarked.

One approach is to use a barrel shaped object much like a motion picture film reel that has a “projector” inside it. The top and bottom is enclosed, but the entire side is either open or enclosed in glass. The center of this canister has three “projectors” that are connected to a server. The server is a computer that manages watermark identifier (ID) assignment for the film and supplies the digital watermark signal in the form of a digital watermark image carrying the appropriate watermark ID as its message payload. The digital watermark signal is repeatedly tiled across this image. (Alternatively, the watermark signal is embedded in precise locations in an image.). Each projector has a display view of 120 degrees. The number of projectors is irrelevant as long as they cover 360 degrees. As the film rolls by, the canister rolls at the same rate exposing the mark to the film. After enough film stock passes by to equal the 36 or 24 exposure roll, the digital watermark server advances to the next digital watermark (e.g., a digital watermark carrying the next unique identifier number) and projects this new mark as the film stock passes. This interchange happens continuously until the number of digitally watermarked rolls ordered is complete.

Another approach is to use a light table that is the length of the typical 36-exposure roll—it can extend to whatever the maximum length of film would be inside a canister. The table width needs to be no more than one film stock width. The machinery grabs the first few sprockets of the film length and pulls it to lie on top of the entire length of the table. The projector on the inside of the light table is connected to the digital watermark server, which supplies the digital watermark image carrying the appropriate ID as above. The projector projects the watermark signal along the length of the table.

In either case, the film production machine processes the hard copy unexposed film by very lightly exposing a digital watermark signal onto the negative/film. The film is spun and packaged as is normally done into the small black plastic canisters. The process can be designed such that each roll has a unique digital watermark, or similarly, so that each pack or group of X rolls has a unique watermark (where X is a selected integer number). The photographer takes normal pictures but inherent in the negative is the originally exposed watermark. This mark can be in any spectrum of color, and embedding in the luminance channel is one example.

This approach of watermarking film enables a variety of applications. For example, in one application, the film canister itself has the watermark ID number listed on it, or carried in a bar code or another digital watermark embedded in an image printed on the canister. The photographer accesses a registration server via a web site on the Internet and enters in the canister ID number—or simply holds the uniquely watermarked canister up to the camera, which extracts the canister ID from the watermark in the image on the canister. Once registered, the user instructs the server where to send his or her watermarked pictures after they are developed.

After using the roll of film, the photographer sends the roll to a photo developing service. The service identifies the photographer from the ID embedded in the images. In particular, it scans the images created from the exposed photographic film, extracts the watermark, including the ID, and sends the ID to the server via the Internet. The server, in turn, looks up the photographer's information supplied at registration time (e.g., name, address, account information and development preferences) and determines where to send the developed pictures, and which account to bill for the service. The developing service may send hard copy photos to a physical address, or electronic images to the photographer's on-line photo library or web site on the Internet. The photographer can then visit the web site to order prints, edit the digital versions of the images, etc.

Watermarking Checks and Other Commercial Paper

Assignee's U.S. patent application Ser. Nos. 09/074,034, 09/127,502, 09/629,649, 09/689,289 and 09/185,380 detail some of the Assignee's prior work concerning application of digital watermarking to valuable documents.

Assignee's U.S. Provisional Patent Application No. 60/316,851 discloses methods and systems for digitally watermarking checks and other commercial paper.

One concept is to authenticate a check, without requiring linkage to an external system. A goal is to determine if the amount or payee of a check has been altered. The attack could be by someone equipped with a scanner and ink jet printer who has the ability to scan a check and reproduce it. The most common attack may be to scan the check, change the amount, and print it. Perhaps printing it many times, with different amounts. Further, printing it with different payees.

In a background printed on the check, an idea is to encode a watermark where each block of the watermark carried in it a multi-bit payload, but where the blocks have differing payloads. So, like some video watermarks, the total message would add up over the sum of the blocks. There would be redundancy within each block, and there might be a couple copies of the total message across the face of the check.

Digital watermarks can serve as a means to detect check fraud. A fragile watermark is provided to help prevent “copies” of a valid check from being proliferated. In this case, a centralized database contains replicas of authorized signatures that are used to detect unauthorized use of the checks. Digital watermark identifiers are used as an index (or key) into that database to look up the authorized signatures.

Fragile watermarking techniques are also helpful in preventing others from reproducing checks (e.g., making copies of valid checks for invalid/unauthorized use). A fragile watermark will not copy properly, providing a clue or tale that the check is a counterfeit. Or to help thwart “look-alike” checks, a fragile watermark may decay when copied such that the absence of or an improper protocol/payload structure is found.

Often times a so-called ‘washing’ process (e.g., chemical processing) is used by forgers to remove ink from a valid check. Forgers are free to alter the payees and amounts on the check once the ink is removed. An improvement is to embed a digital watermark in a check using washable ink. Then, before a check is accepted or cashed, the check is scanned for the expected washable ink digital watermark. If washable ink watermark is missing, then check is considered invalid.

Digital watermarks also provide a self-authenticating functionality. Consider a patron who presents a check to a bank. The bank scans the check to ensure that the check has a digital watermark embedded therein. If a watermark is not found, the check is considered a counterfeit. Also, the watermark may include information such as the maker's account number and issuing bank's routing number or ID. The bank can decode the watermark, obtain the watermark identifier, and compare the watermark identifier against the printed bank and account information or against additional confidential information. The watermark number can also include the check number, which can be similarly verified. By recording the check number, a database record can be maintained to help prevent a counterfeiter from making multiple copies of a single check.

Digital watermarking can be combined with database authentication. Using a watermark identifier, a bank can interrogate a database to check (or verify) the watermark's authenticity, the bank/individual/company/account number/check number, etc. (Randomizing the selection process for assigning a watermark identifier can further enhance security.). The database is preferably the only mechanism used to associate the watermark identifier and the account/bank/check information.

In one embodiment, a signature line is scanned and compared to any authorized signatures in the database. Of course, the appropriate database record is accessed via the watermark identifier as discussed above. Even stolen checks can be detected using such measures.

Methods and device for watermark detection range broadly. Watermark detection devices may include input devices such as conventional web cameras or sophisticated optical sensors and specialized scanning devices. The techniques disclosed in Assignee's U.S. patent application Ser. No. 09/571,422 are particularly helpful to facilitate the linking functionality of this invention.

Watermark-Based Control of a System

In Assignee's U.S. patent application Ser. No. 09/571,422 we disclosed that a Microsoft Excel spreadsheet can be printed onto paper, and as is typical in an office setting, the paper might become buried in a stack of clutter on an office worker's desk. Months later the spreadsheet again becomes relevant and is dug out of the stack. Changes need to be made to the data, but the file name has long-since been forgotten. The worker simply holds the printed page in front of a camera associated with the desktop computer. A moment later, the electronic version of the file appears on the worker's computer display.

When the page was originally printed, tiny droplets of ink or toner were distributed across the paper in a pattern so light as to be essentially un-noticeable, but which steganographically encoded the page with a plural-bit binary number (e.g., 24-128 bits). A database (e.g., maintained by the operating system, the Excel program, the printer driver, etc.) stored part of this number (e.g., 20-32 bits, termed a Universal Identifier, or UID) in association with the path and file name at which the electronic version of the file was stored, the page number within the document, and other useful information (e.g., author of the file, creation date, etc.).

The steganographic encoding of the document, and the updating of the database, can be performed by the software application (e.g., Excel). This option can be selected once by the user and applied thereafter to all printed documents (e.g., by a user selection on an “Options” drop-down menu), or can be presented to the user as part of the Print dialog window and selected (or not) for each print job. When such a printed page is later presented to the camera, the computer automatically detects the presence of the encoded data on the page, decodes same, consults the database to identify the file name/location/page corresponding to the 20-32-bit UID data, and opens the identified file to the correct page (e.g., after launching Excel).

We can link many more types of often-thought-of-as manual computer controls to digitally watermarked objects. Consider digitally watermarking a stack of cards, where each card includes a unique watermark ID. (The cards are optionally designed with different artistic or photographic depictions to help a user distinguish the cards.). A first card is presented to a watermark reader (e.g., a web camera in communication with watermark decoding software). The computer automatically launches a song from the user's play list. When the second card is presented, a web browser is launched and the user's frequent flyer account is displayed. Or when the third card is presented, Microsoft Outlook launches a new email, perhaps addressed to the user's best friend or business associate.

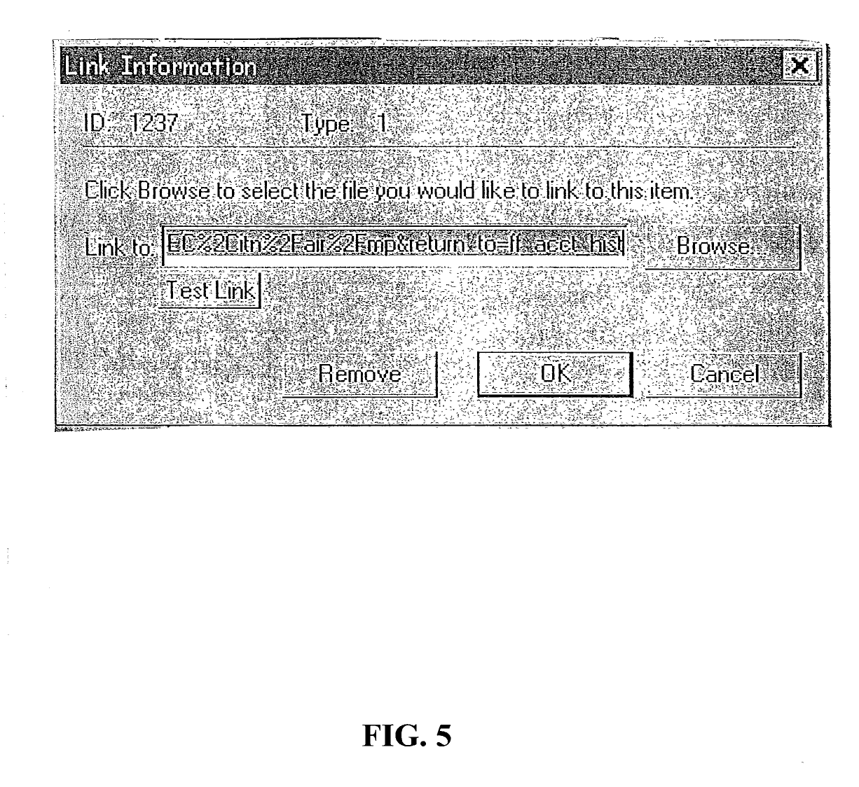

Such functionality is further demonstrated with reference to FIG. 5. A graphical user interface (GUI) allows a user to associate a watermark identifier (e.g., ID: 1237) with a computer action. Once active, the GUI allows the user to enter a specific command line (e.g., “Link to:”). (The command line preferably invokes a “shell execute” command available through Windows. Of course, other command execution techniques are suitably interchangeable with the present invention.). Once entered the user can test the link (“Test Link”), remove a command, or browse for another command, all through the GUI.

Consider the user steps in one embodiment. The user launches the GUI and then presents a watermarked card to the watermark reader. (Alternatively, the GUI automatically launches upon the reader extracting an identifier.). The reader extracts a watermark identifier (e.g., 1237) and the GUI presents an input box for a command or web address (e.g., a command to launch an application, access a website, automatically pay bill through an Internet service, dial a phone number, send a face, play a song from a play list, send an email, shut down the computer, schedule an appointment, etc., etc.). The watermark identifier and the associated command are then stored in a local database. Thereafter, when that watermark identifier is extracted from the watermarked card (or other watermarked document), the database is queried and the corresponding command is executed.

Further improvements are seen as this technology is expanded beyond the traditional “personal computer.” Consider a “smart kitchen,” one where various appliances (oven, microwave, etc.) are controlled by a central household computer (including a digital watermark reader). A watermarked card is presented to the control panel to preheat the oven or initiate a self-clean. A TV dinner package can be digitally watermarked, and the packaging is then preferably used as the watermark card. The same principles hold true for a home/office security system (e.g., to set different security modes), heating/cooling systems (e.g., to set to a predetermined temperature), water processing plants, manufacturing environments, telephone systems, store check-outs, restaurants, etc., etc.

Now consider a car or truck equipped with computer equipment. The computer equipment preferably includes a watermark reader. Digitally watermarked maps, cups, etc. are presented to the reader to control various functions—such as climate control, launching onboard digital maps, calculating routes, setting a cruise control, playing a CD, changing the radio station, reclining a seat to a predetermined position, etc.

We envision that CD and DVD jackets, packaging or cases (and even the CD pit-placement itself—see Assignee's U.S. patent application Ser. No. 09/960,228) will include a digital watermark. A user programs a command line to respond with the CD watermark to launch the CD drive or a ripped copy of a favorite song. These techniques are ideally suited for young children, still trying to master a Windows based operating system. A child presents a watermarked card or game piece (or packaging) to their digital camera. Her parents have preprogrammed the response as discussed above. Instantly the child's favorite learning computer game is launched, or the computer is commanded to establish a videoconference with Grandma.

Indeed, any system that includes a computer and that is equipped with a digital watermark reader can be controlled with these techniques.

Conclusion

The foregoing are just exemplary implementations of the present invention. It will be recognized that there are a great number of variations on these basic themes. The foregoing illustrates but a few applications of the detailed technology. There are many others.

The section headings in this application are provided merely for the reader's convenience, and provide no substantive limitations. Of course, the disclosure under one section heading may be readily combined with the disclosure under another section heading.

To provide a comprehensive disclosure without unduly lengthening this specification, each of the above-mentioned patents and patent applications are hereby incorporated by reference. The particular combinations of elements and features in the above-detailed embodiments are exemplary only; the interchanging and substitution of these teachings with other teachings in this application and the incorporated-by-reference patents/applications are expressly contemplated.

Many of the above-described methods and related functionality can be facilitated with computer executable software stored on computer readable media, such as electronic memory circuits, RAM, ROM, EPROM, flash memory, magnetic media, optical media, magnetic-optical media, memory sticks, hard disks, removable media, etc., etc. Such software may be stored and/or executed on a general-purpose computer, or on a server for distributed use. Also, instead of software, a hardware implementation, or a software-hardware implementation can be used.

In view of the wide variety of embodiments to which the principles and features discussed above can be applied, it should be apparent that the detailed embodiments are illustrative only and should not be taken as limiting the scope of the invention.

What is claimed is:

1. A method of authenticating a wireless audio transmission comprising the steps of:
receiving an audio transmission from a first site at a second site, wherein the first site includes a first digital watermark identifier associated therewith, and the audio transmission includes the first identifier embedded therein in the form of a digital watermark component;
providing the received audio transmission to a digital watermark decoder;
decoding the audio transmission to recover the first identifier;
comparing the first identifier to a predetermined set of authentic identifiers; and
deeming the audio transmission to be authentic only when the first identifier matches at least one of the identifiers in the set of identifiers.

2. A method of obtaining information from a network of computers based at least in part on an environment associated with a first computer, said method comprising:
acquiring optical data corresponding to an object presented within the field of view of an optical sensor device, the optical sensor device communicating with a first computer, wherein the object includes plural-bit data steganographically encoded in thereon, and wherein the first computer communicates with at least a second computer in the network of computers;
decoding the plural-bit digital data from the optical data;
submitting to the second computer at least some of said decoded data and environmental data, wherein the environmental data is associated with the first computer or user; and
determining at the second computer which information to send to the first computer based at least in part on the environmental data.

3. The method of claim 2 wherein the environmental data comprises an indication of whether the first computer comprises at least one of a store kiosk, home computer or mobile device.

4. An optical assembly used in cooperation with an image capture device for optically capturing an image of an object including steganographically encoded data, said assembly comprising:
a dual reflective system comprising:
a first reflective surface, and
a second reflective surface,
wherein the first reflective surface is positioned at a 45-degree angle with respect to the encoded object, and the second reflective surface is positioned so as to be parallel with the first reflective surface, such positioning serving to allow an image capture sensor to be mounted on the same plane as the encoded object.

5. A method comprising:
storing in a database a URL associated with an index number, the URL corresponding to the address of a networked computer on which a web page associated with the index number can be found;
occasionally and automatically changing the URL associated in said database with said index number; and
providing said web page at said changed URLs.

6. A method comprising:
storing in a database a network address that is associated with an index number, the network address corresponding to the storage location on the network for a file associated with the index number;
occasionally and automatically changing a network address that is associated in said database with said index number; and
providing said file at said changed network address.

7. A method of controlling an automated internet web-spider, the spider being adapted to crawl the internet to locate data to index for an associated internet search engine, said method comprising the steps of:
upon encountering image data on the internet, requiring the spider or a computer associated with the spider to search the data to locate a digital watermark;
and if a digital watermark is found in the image data, preventing the spider or the computer associated with the spider from creating a reduced bit representation of the image data unless the watermark otherwise specifies.

8. The method of claim 7 wherein the reduced bit representation comprises a thumbnail image.

9. A method comprising the steps of:
receiving an image comprising an embedded digital watermark;
storing the image in a database for online access; and upon selection of the image,
providing a print of the image to at least a first customer.

10. A method according to claim 9, wherein said providing step comprises notifying a photo-processing lab to generate the print.

11. The method according to claim 9, wherein the print is at least one of a digital print and a physical print.

12. The method according to claim 11, wherein the print comprises the digital watermark.

13. A method comprising the steps of:
capturing an image;
digitally watermarking the captured image to include plural-bit data;
storing the watermarked captured image for internet access;
associating additional information with the watermarked captured image;
upon request, providing a print of the watermarked captured image to a requestor;
providing the additional information upon request.

14. The method according to claim 13, wherein the additional information comprises copy control information.

15. A method according to claim 13, wherein said providing step comprises notifying a photo-processing lab to generate the print.

16. A method of authenticating an identification document comprising:
presenting the identification document to a sensor station;
generating optical data corresponding to the identification document;
processing the optical data to extract a first set of auxiliary data steganographically encoded therein;
machine-sensing first information carried by the identification document, the first information being separate, but related, to the first set of auxiliary data;
checking correspondence between the machine-sensed first information and the first set of auxiliary data extracted from the identification document; and
further processing the optical data to extract a second set of auxiliary data steganographically encoded therein, the second set of auxiliary data evidencing degradation upon copying or signal processing,
wherein the identification document is determined to be not authentic if either: i) the first information and the first auxiliary data do not correspond, or ii) the second set of auxiliary data evidences degradation or is undetectable.

17. A method of authenticating an identification document comprising:
presenting the identification document to an optical sensor station;
generating optical data corresponding to the identification document;
processing the optical data to extract a first set of auxiliary data steganographically encoded therein, wherein the first set of auxiliary data comprises characteristics that evidence degradation upon copying or signal processing;
wherein the identification document is determined to be not authentic when the second set of auxiliary data evidences degradation or is undetectable.

18. A digital watermark embedding process comprising the steps of:
dividing a source signal into a plurality of blocks or segments;
embed a unique watermark component in each of the plurality of blocks or segments, wherein the unique component comprises information related to the location of its respective block within the source signal or to a type of security features associated with the source signal.

19. An object authentication process, the object comprising a digital watermark embedded therein, wherein the object is divided into a plurality of blocks or segments, and a unique watermark component is embedded in each of the plurality of blocks or segments, wherein the unique component comprises information related to the location of its respective block within the object or to a type of security features associated with the object, said method comprising the steps of:
extracted the block watermark components from the digitally watermarked object;
mapping at least a subset of the components to corresponding authentication information; and based on the authentication information,
determining whether the object is authentic.

20. A method of detecting steganographic embedding comprising the steps of:
embedding a steganographic authentication watermark in media content, wherein the authentication watermark comprises characteristics that are dependent upon the media content; and
detecting whether the steganographic authentication watermark has changed, the change indicating that the underlying content has changed.

21. The method of claim 20, wherein a change in the content signifies that unexpected steganographic embedding has occurred.

22. A graphical computer interface to facilitate the association of an embedded object with a computer response, said interface comprising
a first interface to allow a user to enter a command line to associate an identifier that is embedded in the object with a computer response; and
a second interface to test an entered command to ensure that the entered command is acceptable to the user.

23. The method of claim 22 wherein the command line invokes a Windows shell execute command.
